(19) United States
(12) Patent Application Publication
(10) Pub. No.: US 2005/0149967 A1
(43) Pub. Date: Jul. 7, 2005

(54) System and method for managing software alert messages on televisions

(76) Inventors: Mark G. Hanley, Skamania, WA (US); Edwin G. Brown, Vancouver, WA (US); Jon A. Fairhurst, Camas, WA (US)

Correspondence Address: MARGER JOHNSON & MCCOLLOM, P.C. - SHARP, 1030 SW MORRISON STREET, PORTLAND, OR, 97205, US

(21) Appl. No.: 10/977,067

(22) Filed: Oct. 29, 2004

Related U.S. Application Data
(60) Provisional application No. 60/535,093, filed on Jan. 6, 2004.

(51) Int. Cl. H04N 7/025; H04N 7/10; G06F 3/00; H04N 5/445; G06F 13/00

(52) U.S. Cl. 725/32

(57) ABSTRACT

A method for displaying messages on a television screen comprising the steps of (a) displaying a video signal on the screen; (b) receiving at the screen an incoming notification message including a dialog and an icon associated therewith; (c) displaying the icon on the video screen in combination with the video signal, and (d) only displaying the dialog responsive to a user-initiated action.

### CROSS-REFERENCES TO RELATED APPLICATIONS

This application claims the benefit from U.S. Provisional Patent Application No. 60/535,093 filed Jan. 6, 2004 whose contents are incorporated herein for all purposes.

### BACKGROUND OF THE INVENTION

1. Field of the Invention

The invention relates to interactive television systems, and more particularly to methods for communicating important alert messages to the viewer while they are engaged in viewing a television.

2. Description of the Prior Art

Televisions have been commonly paired with remote controls for operating television functions such as channel selection, volume adjustment and other functions. Television displays use a variety of different technologies such as cathode ray tubes (CRT), flat panel plasma displays, liquid crystal displays, projection screen displays, and others. Such displays are typically used to display content (broadcast via cable, antenna, or satellite) for viewing by a television viewer. More recently, such displays have also been used to display software applications such as personal video recording functions and others. These applications may reside on a CPU in the television, or on another CPU on a network that the TV is connected to.

A problem arises when a software applications (source) wishes to communicate important messages, herein called “notifications”, to the viewer while they are engaged in viewing the television broadcast content or operating an application. Examples of these notifications are appointment reminders; signals from devices such as caller ID codes with telephones, weather warnings, etc.

A traditional PC paradigm is that a dialog box is displayed demanding the viewer's immediate attention. Given the resolution of a standard television, the dialog can consume a large portion of the screen making for an annoying television viewing experience.

Accordingly, the need remains for a method that minimizes the intrusion of notifications on the viewing experience over those methods known in the prior art.

### SUMMARY OF THE INVENTION

Whereas the prior art resides in computers where software applications compete on equal footing with one another, the present invention is customized for television where the video viewing has the highest priority, and where the main control is the television remote control.

The invention minimizes the intrusion on TV viewing by software applications (sources) wishing to communicate (notify) the viewer. The invention associates a relatively small icon with the notification message and displays the icon over the video until the viewer manually requests to see the notification message (dialog information).

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a remote control device constructed to implement the invention.

FIG. 2 is an alternate embodiment of a remote control.

FIG. 3 is a block diagram showing a system for implementing a preferred embodiment of the invention.

FIG. 4 is representative of a screen image showing a user interface implemented according to the present invention.

FIG. 5A-D show icons representative of different alerts used for the notification system of the present invention.

### DETAILED DESCRIPTION

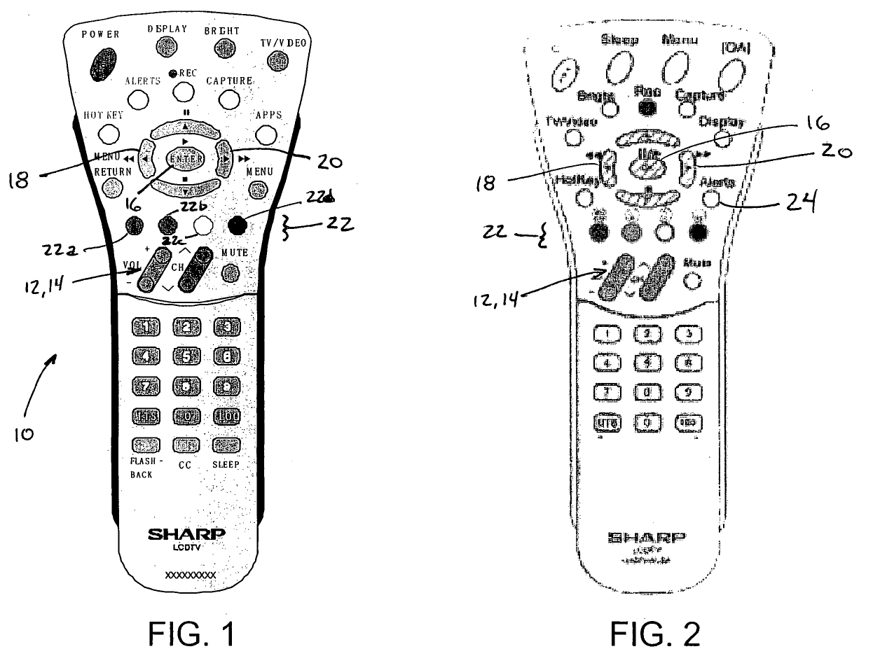

A television remote control usable to implement the present invention is shown at 10 in FIG. 1. Remote control 10 includes buttons dedicated to television functions, such as volume up/down buttons 12, 14, and those that have a contextual function such as <ENTER> 16, left 18 and right 20 buttons. Remote control 10 further includes an additional set of uniquely colored (or symbolically labeled) buttons 22—such as red button 22a, green button 22b, yellow button 22c and blue button 22d on the remote control. The actions of the buttons 22 are dedicated to features of the invention, but the results of pushing the buttons are contextual in nature.

FIG. 2 is an alternate embodiment of the remote control of FIG. 1 which cycles through alert messages using a dedicated button 24.

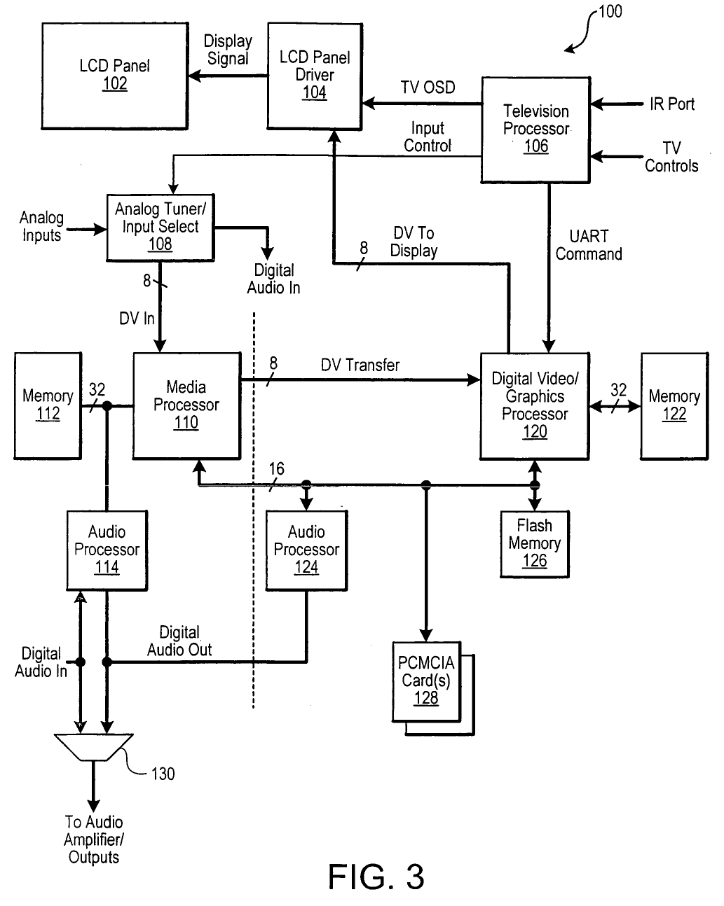

FIG. 3 contains a block diagram for a Liquid Crystal Display (LCD) television capable of operating according to some embodiments of the present invention. Television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

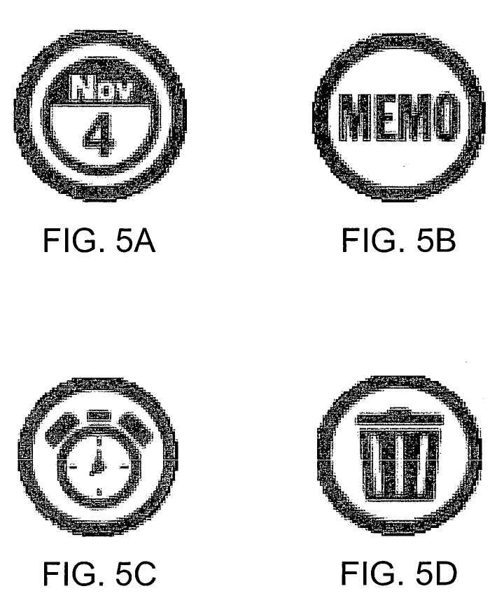

A television processor 106 provides basic control functions and viewer input interfaces for television 100. Television processor 106 receives viewer commands, both from buttons located on the television itself (TV controls) and from a handheld remote control unit (not shown in FIG. 5, but like remote 10) through the IR Port. Based on the viewer commands, television processor 106 controls an analog tuner/input select section 108, and also supplies user inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 110 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

The television system 100 can communicate with a remote computer via an 802.11 wireless network. In a preferred embodiment, a wireless PCMCIA card is inserted into one of two PCMCIA slots 128 [FIG. 3]. This hardware is then exercised by an 802.11 driver in the DVG processor 120 [FIG. 3]. The communication protocol is TCP/IP.

Incoming alerts/notifications are stored in a list in memory 122 and the most recent are mapped to the colored buttons 22 of remote control 10. Since at any given time, there may be more notifications than colored buttons 22, one of the buttons 22a, 22b, 22c or 22d is then reserved for navigating through the notification list. In the alternative, all buttons 22 can be used and a dedicated alert scroll button 24 may be used in place of one of the colored buttons 22. Should a new notification arrive while navigating through the list, the most recent notifications are again mapped to the colored buttons, and their accompanying icons redisplayed. In one arrangement, the buttons are mapped left to right so that the most recent notification is mapped to the leftmost (red button 22a) to reflect an English speaker's propensity to read from left to right.

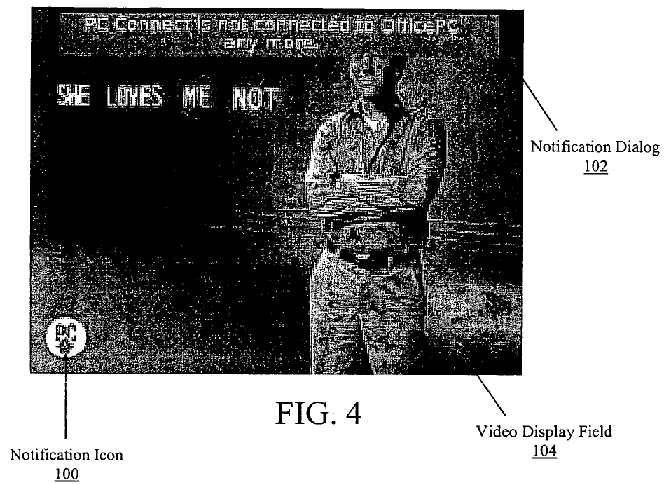

FIG. 4 illustrates a screen shot showing a notification icon 100 mapped to the blue color button 22d. The icon is displayed in a blue color to indicate the color of the alert button (here the blue button 22d) to which the icon has been mapped. The icon appears as a small graphic at the corner along the bottom of the screen so as not to unduly interfere with the material currently being displayed on the video display field 104. If the blue button is pressed by the user, a notification dialog 102 corresponding to the icon is displayed on the screen.

In the alternative, notification icons 100 are displayed with a border having the same color as the button 22 to which the notification message is associated. Other icons and notifications are possible, examples of which are shown in FIGS. 5A-D—a calendar notification icon (FIG. 5A), a memorandum trigger icon (FIG. 5B), a delete notification icon (FIG. 5C), and an alarm notification icon (FIG. 5D). The viewer is now in a position to read the notification at their leisure by pushing the colored button 22 on the remote control 10 whose color and relative position matches that of the displayed icons. Doing so will “action” the icon causing a dialog generated from the notification data to appear. This dialog may require further user input, in which case, the colored buttons are remapped to the dialog in the same manner as the previous mapping. Pressing a colored button 22 now will trigger the dialog, which may communicate the user selection to the source. This is dependant on what action the source has assigned to the dialog button in the notification data and will remove the notification from the list. This removal will of course cause a remapping of notifications to colored buttons, along with a subsequent redisplay of their icons.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A method for displaying messages on a television screen comprising the steps of:
(a) displaying a video signal on the screen;
(b) receiving at the screen an incoming notification message including a dialog and an icon associated therewith;
(c) displaying the icon on the video screen in combination with the video signal, and
(d) only displaying the dialog responsive to a user-initiated action.

2. The method of claim 1, further including (e) associating the incoming notification message with a button on a remote control, wherein the user-initiated action is pressing the associated button.

3. The method of claim 2, further including (f) providing a plurality of differently colored buttons on the remote control, and associating the incoming notification message with a respective one of the colored buttons.

4. The method of claim 3, further including the step of (g) associating a second incoming notification message with a second one of the colored buttons on the remote control.

5. A method for displaying messages on a television system including memory, a television screen, and a remote control comprising the steps of:
(a) displaying a video signal on the screen;
(b) receiving at the system a plurality of incoming notification messages including for each incoming message a dialog and an icon associated therewith;
(c) storing the incoming notification messages in a list in memory;
(d) mapping most recently received incoming notification messages to one-touch buttons on the remote control;
(e) displaying icons for the most recently received incoming notification messages on the television screen;
(f) detecting a one-touch button actuation; and
(g) responsive to the detected one-touch button actuation, displaying on the screen a dialog associated with the detected one-touch button.

6. The method of claim 5, further including the step of reserving one of the one-touch buttons for navigating through the notification list should the number of received incoming notification messages exceed the number of one-touch buttons.

7. The method of claim 5, further including the step of providing a plurality of differently colored buttons on the remote control, and associating the incoming notification message with a respective one of the colored buttons.

8. The method of claim 5, further including the step of removing the notification message from the list subsequent to the step of displaying the dialog of the message on the screen.

9. The method of claim 8, further including remapping the one-touch buttons to the notification messages in the list and redisplaying icons on the screen associated with the notification messages in the list.
